(19) United States
(12) Patent Application Publication
(10) Pub. No.: US 2012/0055854 A1
(43) Pub. Date: Mar. 8, 2012

(54) Filter Method for Separating Unbound Ferrofluid from Target-bound Ferrofluid in a Biological Sample

(76) Inventor: Arjan G.J. Tibbe, Deventer (NL)

(21) Appl. No.: 13/147,908

(22) PCT Filed: Feb. 5, 2010
(86) PCT No.: PCT/US10/23388

§ 371 Date: Nov. 15, 2011

Related U.S. Application Data
(60) Provisional application No. 61/150,078, filed on Feb. 5, 2009.

(51) Int. Cl. B03C 1/02

(52) U.S. Cl. 209/214; 209/215

(57) ABSTRACT

A filtering system for separating unbound ferrofluid from bound ferrofluid in the enrichment of a target entity in a biological sample. The filtering device of the present invention has application in the isolation target cells from unbound ferrofluid during separation with a permanent magnet (floater) mechanism. This process reduces interference of unbound ferrofluid during subsequent image analysis or enumeration of cells by image cytometry. The system has application in the assessment of target populations such as leukocyte subsets in different bodily fluids or bacterial contamination in environmental samples, food products and bodily fluids. Briefly, fluorescently labeled target cells are linked to magnetic particles or beads. The linkage process results in a mixture having a population of contaminating unbound magnetic particles. In one embodiment for separation, a small, permanent magnet is inserted directly into the chamber containing the labeled cells. The magnets are coated with PDMS silicone rubber to provide a smooth and even surface which allows imaging on a single focal plane. A filter is positioned on a cover of the floater device to allow unbound ferrofluid to pass through the pores, but restrict the passage of the target entity. The floater and filter are removed from the sample and the filter surface is illuminated with fluorescent light emitted by the target cells captured by a CCD camera. Image analysis can be performed with a novel algorithm to provide a count of the cells on the surface, reflecting the target cell concentration of the original sample.

### FIELD OF THE INVENTION

The invention relates generally to imaging target components in a fluidic (biological) sample. More specifically, methods and apparatus are described that provide for the separation of bound and unbound ferrofluid particles during a positive selection of target cells from a blood sample.

### BACKGROUND ART

The use of immunomagnetic separation technology provides greater sensitivity and specificity in the detection of target entities in blood for example, but not limited to, intact circulating cancer cells and endothelial cells. This simple and sensitive diagnostic tool, as described (U.S. Pat. No. 6,365,362; U.S. Pat. No. 6,551,843; U.S. Pat. No. 6,623,982; U.S. Pat. No. 6,620,627; U.S. Pat. No. 6,645,731; WO 02/077604; WO03/065042; and WO 03/019141) can be used in the present invention to correlate the statistical survivability of an individual patient based on a threshold level.

A prior diagnostic tool incorporates a blood sample from a cancer patient (WO 03/018757) incubated with magnetic beads, coated with antibodies directed against an epithelial cell surface antigen as for example EpCAM. After labeling with anti-EpCAM-coated magnetic nanoparticles, the magnetically labeled cells are then isolated using a magnetic separator. The immunomagnetically enriched fraction is further processed for downstream immunocytochemical analysis or image cytometry, for example, in the CellSpotter or CeIlTracks® System (Immunicon Corp., USA). The magnetic fraction can also be used for downstream immunocytochemical analysis, RT-PCR, PCR, FISH, flowcytometry, or other types of image cytometry.

The CellSpotter or CellTracks® System utilizes immunomagnetic selection and separation to highly enrich and concentrate any epithelial cells present in whole blood samples. The captured cells are detectably labeled with a leukocyte specific marker and with one or more tumor cell specific fluorescent monoclonal antibodies to allow identification and enumeration of the captured CTC's as well as instrumental or visual differentiation from contaminating non-target cells. At an sensitivity of 1 or 2 epithelial cells per 7.5 ml of blood, this assay allows tumor cell detection even in the early stages of low tumor mass.

EasyCount® system (PCT/US03/04468) is a fluorescent imaging system, designed to make a distinction between lymphocytes, granulocytes and monocytes. The system includes a compact electronic optical instruments, analytical methods, image acquisition, and data reduction algorithms for the detection and enumeration of magnetically labeled target cells or particles. Using whole blood as an example, blood cells are fluorescently labeled using one or more target specific fluorescent dyes, such as a DNA staining dye. The cells of interest or target cells in the blood sample are labeled by incubation with monoclonal antibodies conjugated to ferromagnetic particles. The sample is then placed into an appropriate optical detection chamber or covet, which in turn is placed into a magnetic field gradient that selectively causes the magnetically labeled cells to move towards the planar viewing surface of the chamber. The target cells are collected and immobilized substantially uniformly on the optically transparent surface of the chamber. A segment of this surface and the labeled target cells thereon are illuminated by means of one or more LED (light emitting diodes). Subsequently, the light emitted by individual target cells is captured by a CCD (charge coupled device). Image acquisition methods, processing methods, and algorithms, disclosed herein, are used to count the number of captured light-emitting cells and to relate the data output to the target cells per microliter of the analysis sample in the chamber and ultimately to the original specimen.

Recently, positive selection and imaging of target entities have been described using a small permanent magnet (WO2006/102233). In this method, a coated permanent magnetic device is placed within the sample for magnetic manipulation. The system immunomagnetically concentrates the target entity, fluorescently labels, identifies and quantifies target cells by positive enumeration. Subsequent statistical analysis enables the clinician to obtain potential diagnostic information. After obtaining a whole blood sample from a patient, a small permanent magnet is added to the whole blood sample. A small NdFeB magnet is directly added to a sample container. After 10 minutes the small permanent magnet is pulled out of the sample using an iron rod or another magnet. The magnet is positioned within the container to allow for image analysis.

A further embodiment of the present invention has the magnet fixed to a floatation device (floater) within the reaction chamber. After addition of the reagents, blood and floater, the immunomagnetically labeled target cells are positioned along a single imaging plane for analysis, all within the reaction chamber. One draw-back with this process is the presence of unbound ferrofluid, positioned along the same imaging plane.

Currently available methods incorporate unbound ferrofluid into the imaging process which could result in the analysis. Thus, there is a clear need to remove or separate the unbound ferrofluid from the ferrofluid bound to target entities. The present invention provides a filter device to achieve such a purpose.

### SUMMARY OF THE INVENTION

The present invention is a method and means for separating unbound ferrofluid from target bound ferrofluid in a biological sample when positive selecting and imaging target entities using permanent magnets. The process involves the addition of a coated permanent magnetic device for magnetic manipulation. The system immunomagnetically concentrates the target entity onto a filter device having porosity such that passage of the target is restricted while the small unbound ferrofluid is allowed to pass toward the collection surface of the permanent magnet. The filtering device allows for the target to be fluorescently labeled, identified and/or quantified by positive enumeration after separation from unbound ferrofluid. Subsequent statistical analysis enables the clinician to obtain potential diagnostic information.

In the floater device, a filter is positioned on the collection surface to restrict passage of the target, yet allow smaller, unbound ferrofluid to collect on the collection surface of the floater.

### BRIEF DESCRIPTION OF THE DRAWINGS

FIG. 1: Panel A shows a diagram of the floater having a filter positioned on the cover of the collection surface of the permanent magnet. Inset shows a magnified view of the side of the filter and floater device, depicting the orientation of the spacer, filter, and collection surface. Panel B shows a top view of the filter device with an air outlet means.

FIG. 2: Image displaying an overlay color image of cells that are collected on a nylon woven filter with 3 micron pores (panel A) or 5 micron pores (panel B).

FIG. 3: Image showing unbound ferrofluid separation is less efficient at the edges of the filter. Panel A is a 5x image of control cells on the filter. Panel B is the circled area of Panel A at a 40x image.

FIG. 4: Representation of a microsieve with target cells collected on the surface.

FIG. 5: Image displaying microsieve with collected control cells. Panel A shows control cells on a microsieve with 5 micron pores. Black bars are support structures and the interspaced gray area contains the 5 micron pores. Panel B is a 40x image of the control cells with the ferrofluid passing through the gray region.

FIG. 6: Representation of the pillar structure and the separation of unbound ferrofluid from cells. The pillar structure restricts further movement of the cells between the pillars, yet allows unbound ferrofluid to collect between the pillars. The enlarged view shows unbound ferrofluid collecting between the pillars.

FIG. 7: Fluorescent images acquired using three different objectives. (A) Image acquired using 5x NA 0.12 objective. (B) Image acquired using 10x, NA 0.25 and a (C) Image using 40x, NA 0.6 objective. Blue color represent DAPl, green is CD8-PE and red is CD4-APC.

FIG. 8: Images obtained with a 5x and 40x objective with the addition of 20, 40, 60, and 80 microliters of EpCam ferrofluid (20 mg/ml).

### DETAILED DESCRIPTION OF THE INVENTION

Immunomagnetic isolation, enrichment, and analysis in blood combine immunomagnetic enrichment technology and immunofluorescent labeling technology with an appropriate analytical platform after initial blood draw. The associated test has the sensitivity and specificity to detect rare cells in a sample of whole blood with the utility to investigate their role in the clinical course of the disease such as malignant tumors of epithelial origin.

With this type of technology, circulating tumor cells (CTC) have been shown to exist in the blood in detectable amounts.

Image cytometric analysis such that the immunomagnetically enriched sample is analyzed by the CellSpotter and CellTracks® System utilizes a fluorescence-based microscope image analysis system, which in contrast with flowcytometric analysis permits the visualization of events and the assessment of morphologic features to further identify objects (U.S. Pat. No. 6,365,362).

The CellSpotter and CellTracks® System refers to an automated fluorescence microscopic system for automated enumeration of isolated cells from blood. The system contains an integrated computer controlled fluorescence microscope and automated stage with a magnetic yoke assembly that will hold a disposable sample cartridge. The magnetic yoke is designed to enable ferrofluid-labeled candidate tumor cells within the sample chamber to be magnetically localized to the upper viewing surface of the sample cartridge for microscopic viewing. Software presents target cells, labeled with antibodies to cytokeratin and having epithelial origin, to the operator for final selection.

Isolation of target cells can be accomplished by any means known in the art. After magnetic separation, the cells bound to the immunomagnetic-linked antibodies are magnetically held at the wall of the tube. Unbound sample is then aspirated and an isotonic solution is added to resuspend the sample. A nucleic acid dye, monoclonal antibodies to cytokeratin (a marker of epithelial cells) and CD 45 (a broad-spectrum leukocyte marker) are incubated with the sample. After magnetic separation, the unbound fraction is again aspirated and the bound and labeled cells are resuspended in 0.2 ml of an isotonic solution. The sample is suspended in a cell presentation chamber and placed in a magnetic device whose field orients the magnetically labeled cells for fluorescence microscopic examination. Cells are identified automatically and candidate target entities presented to the operator for checklist enumeration. An enumeration checklist consists of predetermined morphologic criteria constituting a complete cell.

Another reported means to isolate target cells utilizes a permanent magnet (WO2006/102233) which is added directly to immunomagnetically separate the labeled target entity for other components in a blood sample. The target is further labeled with imaging nucleic acid dyes, cell membrane, and/or cytoskeletal immunofluorescent labels. A small neodymium (NdFeB) permanent magnet is added to a whole blood sample after immunomagnetically labeled and fluorescently labeled for CD4. After 10 minutes, the small permanent magnet is separated from the fluid sample and within the sample container to be viewed through a viewing surface.

Example 1 demonstrates the ability to collect and image target entities, for example subpopulations of cells, on the collection surface of the floater. Example 2 shows the decline in image quality with an increase in unbound ferrofluid. Cells become buried under a layer of ferrofluid, resulting, in part, in low recoveries.

Because the separation process does not distinguish between bound and unbound ferrofluid particles, both forms are collected on the collection surface of the permanent magnet. Consequently, unbound ferrofluid can interfere with the imaging process of the target entity.

Thus, there is a further need to design a method and device to separate the unbound ferrofluid from the ferrofluid prior to imaging in order to provide a target entity, free of interfering unbound ferrofluid.

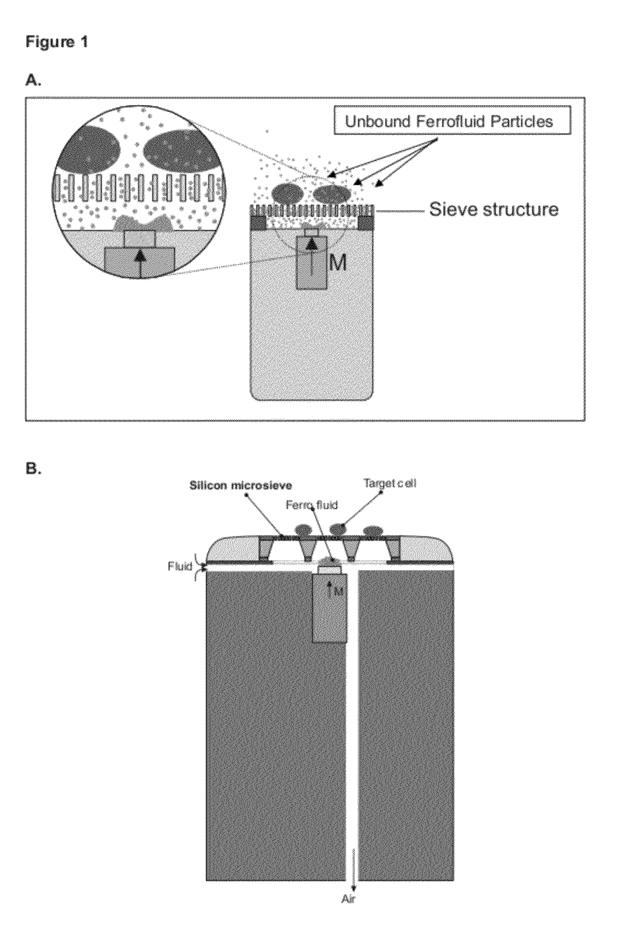

One embodiment provides a means to prevent the interference of unbound ferrofluid by filtrating prior to collection on the imaging surface. The unbound ferrofluid is allowed to collect on a glass covering of the magnet collection surface while the target entity remains on the collection surface of a filter device. In this collection means, unbound ferrofluid passes through a filter while the target entity remains on the filter surface. As shown in FIG. 1, the collection surface of the floater (WO2006/102233) is closed with a glass surface. The filter is separated from the magnet collection surface by a spacer means. On example of a spacer means is shown in Panel A. The spacer consists of two halves which are spaced apart approximately the same distance as the diameter of the magnet. A filter is positioned with a pore size that will allow unbound ferrofluid to traverse, yet restrict the movement of the target. Thus, the unbound ferrofluid will collect on the glass surface of the magnet while the target entity, bound to ferrofluid, will collect on the filter surface. The present invention further considers the problem of air entrapment beneath the filter. When this occurs, unbound ferrofluid will not be able to travel through the filter and collect on the collection surface of the magnet. Consequently, the filter device must include an air escape means. FIG. 1, Panel B depicts one embodiment for removing air by having an outlet means between flanking the spacers.

Any filter known in the art is considered in the present invention. However, some filters will work better than others, depending upon target and optimization conditions. These include, but not limited to, nylon woven filters (Sefar Filtration, Goor, The Netherlands) and Microsieves (Aquamarijn, Zutphen, The Netherlands).

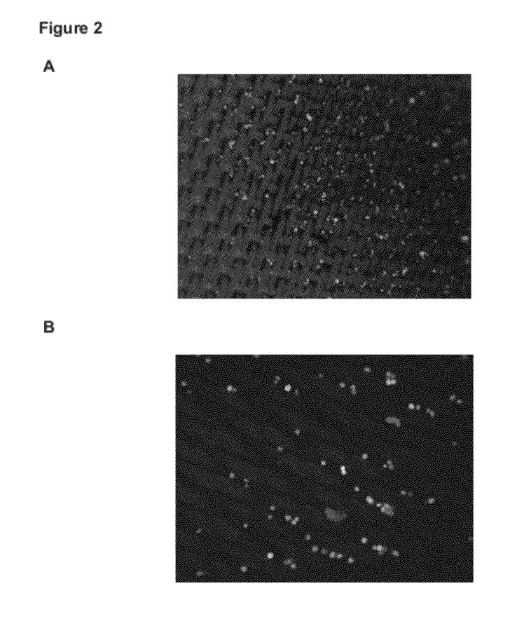

FIG. 2 shows an image of the filter surface using nylon woven fibers. In this example, CellSearch control cells were removed from the cartridge and transferred to the glass tube. An additional 1.5 ml of system buffer is added. With the floater and filter depicted as in FIG. 1, the floater and filter device were added to the sample and the sample rotated for 15 minutes on a clinical rotating device. The floater was imaged using a fluorescence microscope with the images shown in FIG. 2. FIG. 2 shows the results using woven filters. Each panel depicts overlay color images of cells that are collected on an nylon woven (Sefar Filtration, Nitex 03-1/1) filter. Panel A has a porosity of 3 microns and Panel B has a porosity of 5 microns. From the images, the control cells in Panel A restrict the passage of unbound ferrofluid and target cells. One potential explanation for this restriction is that under a magnetic field unbound ferrofluid attach to each other and thereby increases in size. Additionally, they orient themselves along the magnetic field lines forming long needle like structures. This orientation further restricts unbound ferrofluid movement through the membrane. Panel B has a porosity that will allow passage of unbound ferrofluid and restriction of the target entity.

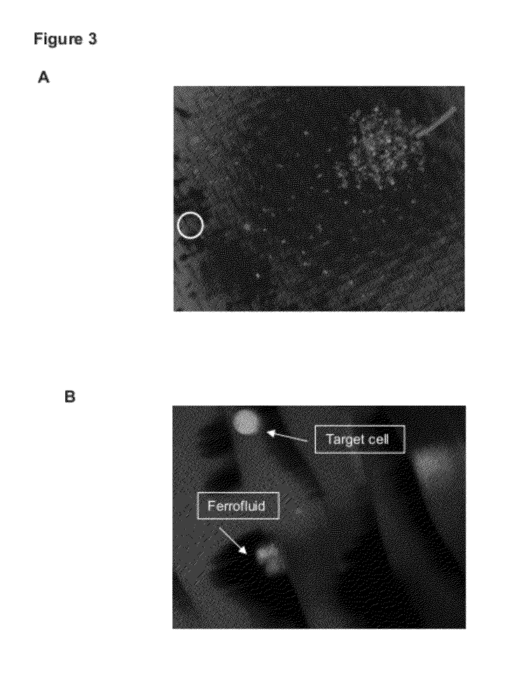

FIG. 3 shows the efficiency of ferrofluid removal across the filter collection surface using overlay images. Pane A is a 5x image of the collection surface depicting the relative collection of unbound ferrofluid and target cells. The dark regions are collected unbound ferrofluid. Less of the unbound ferrofluid is in the center of the filter, resulting in a better separation of unbound ferrofluid. Panel B provides a 40x image of the encircled area of Panel A. The needle like dark structures are unbound ferrofluid oriented in long needle structures. The orientation of these needle structures inhibits passage of unbound ferrofluid.

Nucleopore & Cyclopore Filters (Whatman, US) do not provide for the separation necessary under these conditions. With these filters, the number of pores in the filters do not provide for efficient removal of unbound ferrofluid (i.e. the porosity of these filters is too low).

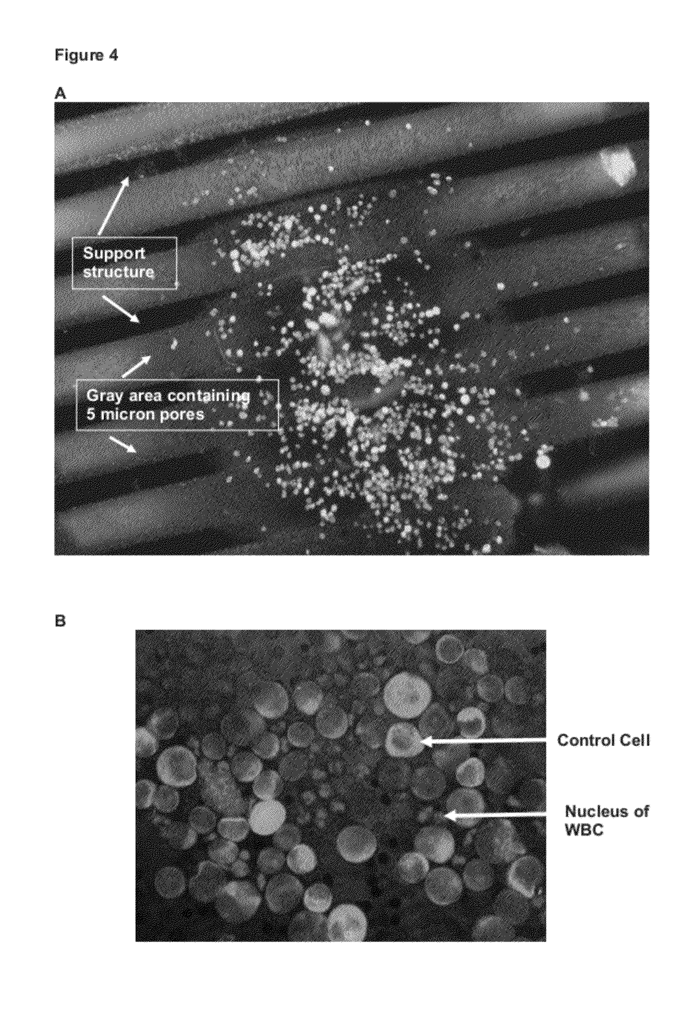

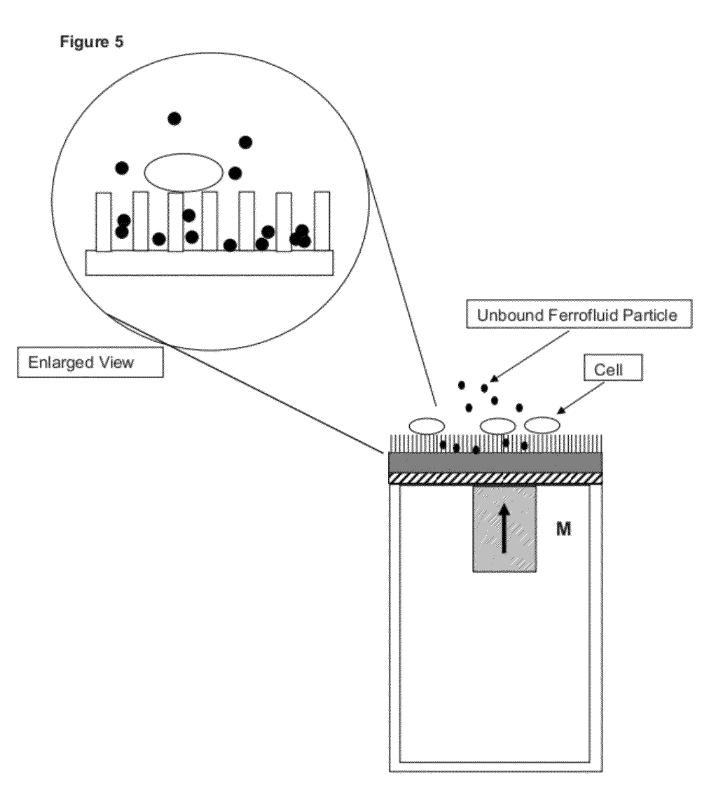

However, Microsieves (Aquamarijn, Zutphen, The Netherlands) provide good separation of unbound ferrofluid. Microsieves are produced using silicon micromachining. The pores, which are well defined by photolithographic methods and anisotropic etching, allow for accurate separation of particles based upon size. The membrane thickness is usually smaller than the pore size in order to keep the flow resistance small (usually one to three orders of magnitude smaller than other types of filtration membranes). FIG. 4 shows an example of a microsieve with cells on the collection surface. FIG. 5 displays a microsieve using an image overlay of collected control cells. The control cells are shown on a microsieve with 5 micron pores. The black bars are supportive structures with the height of these bars approximately 600 microns. The light gray areas are the regions with 5 micron pores having a thickness of 3 microns. Panel B is the same microsieve under 40x imaging of control cells. The bright events are target cells. The unbound ferrofluid easily pass through the regions that have pores, but areas where there is a supportive structure (dark regions) the unbound ferrofluid collects. So while the pores of the microsieve provide a very good filtering means for the present invention, the support regions along the filter's collection surface are less than satisfactory for filtering unbound ferrofluid.

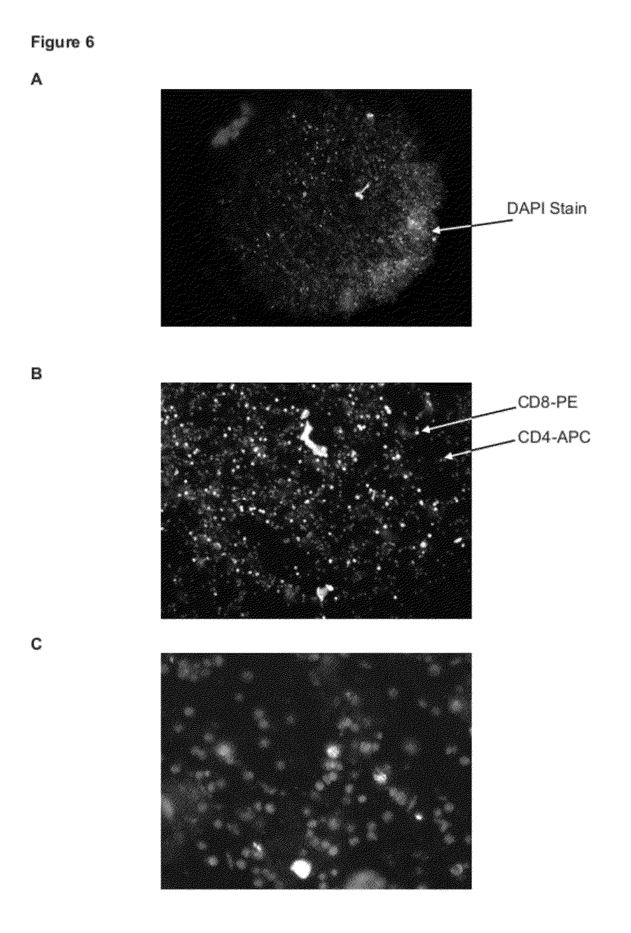

In another embodiment of the present invention, a small pillar structure is used where the pillars are smaller than the size of individual cells. As a result unbound ferrofluid lodges between the pillars while the cells remain along the top. As modeled in FIG. 6, unbound ferrofluid and ferrofluid, bound to target entities, are magnetically attracted to the cover of the permanent magnet. However, the bound ferrofluid (and consequently the target entity) remain on top of the pillar structure while the smaller, unbound ferrofuid particles travel between the pillars and collect within the pillars structure. The region where the cells are collected along the pillars is directly under the magnet. At the positions where the magnetic field lines match with the pillar structure, unbound ferrofluid is attracted between the pillars. Outside this region unbound ferrofluid builds up as lines. The end result removes the unbound ferrofluild particles from the target entity focal plane which is along the top of the pillar structure. Without the pillars, the cells would be completely buried underneath the unbound ferrfluid.

### EXAMPLE 1

### CD-Chex, Capture Efficiency

To determine the capture efficiency CD-Chex with known absolute numbers of leukocytes and their phenotypes is used.

### Materials and Methods:

CD-Chex (lot #60650071):
   CD3+:1859/μl
   CD3+/CD4+:1221/μl
   CD3+/CD8+:576/μl

To 50 μl of CD-Chex, add 10 μl of CD3-FF (clone Cris7), 10 μl of CD4-APC and 10 μl of CD8-PE. After 25 minutes of incubation, 10 μl of this solution is injected into the chamber. PBS (1.8 ml) is added with 100 μl DAPl. The floater is then inserted. After capping, the chamber is placed on a rocker and rotated overnight (approximately 16 hrs). The chamber is inverted and the images of the floater are acquired.

### Results:

For 100% capture efficiency, the floater surface contains:
CD3+:10328 cells
CD3+/CD4+:6783 cells
CD3+/CD8+:3200 cells

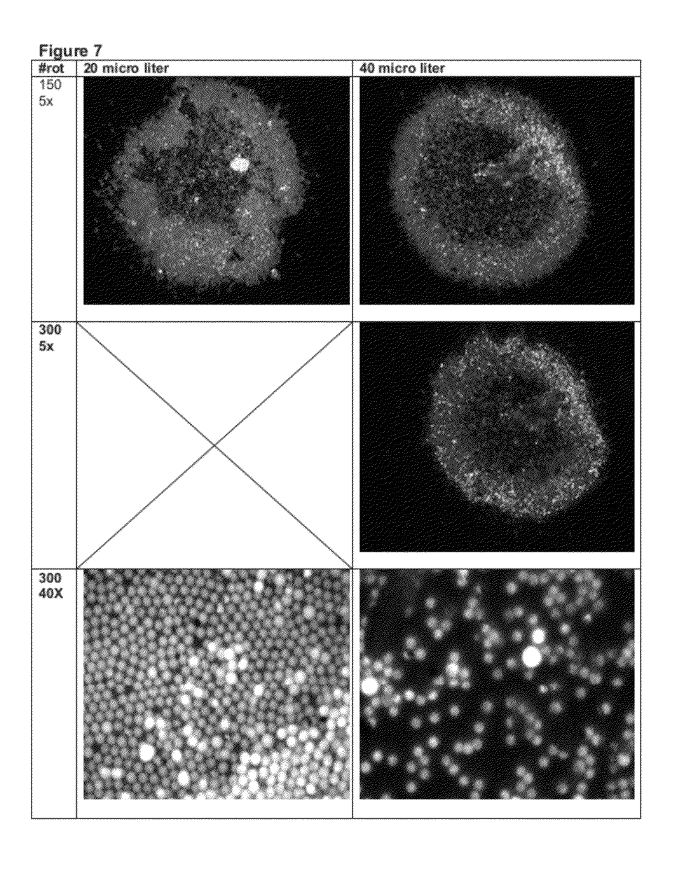

Images are acquired with different objectives and the resulting over-lay images are presented as shown in FIG. 7. FIG. 7A displays the image acquired using a 5x NA 0.12 objective. FIGS. 7B and 7C are acquired using a 10X, NA 0.25 and a 40X, NA 0.6 objective, respectively. The blue color represents the DAPl, green is CD8-PE and red is CD4-APC. With the number of CD8-PE (green) labeled cells expected to be 3200 and the actual number of CD8-PE labeled cells equal to approximately 500, the capture efficiency will be 16%.

### EXAMPLE 2

### Amount of Ferrofluid

To determine the quality of image with increasing ferrofluid. As the amount of ferrofluid increases the image quality decreases. Cells become buried under a layer of ferrofluid and are invisible for detection. This results, in part, in the low recoveries.

### Materials and Methods:

COMPEL Magnetic Microspheres, Dragon green, 2.914 10⁷/ml, diameter 8.44 microns, lot#6548 (Bangs Laboratories Inc, Catalog code UMC4F) were diluted 1:100. System buffer (1.5 ml) was added to the glass vial and 50 microliters containing 14570 beads were added together with 20, 40, 60 and 80 microliters of EpCam ferrofluid (20 mg/ml). Fluorescence images were acquired after 15 and 30 minutes of rotation. Test tube rotator was set at 10 rpm, resulting in 150 and 300 rotations.

Floater is Corning 1/16″ diameter magnet.

### Results:

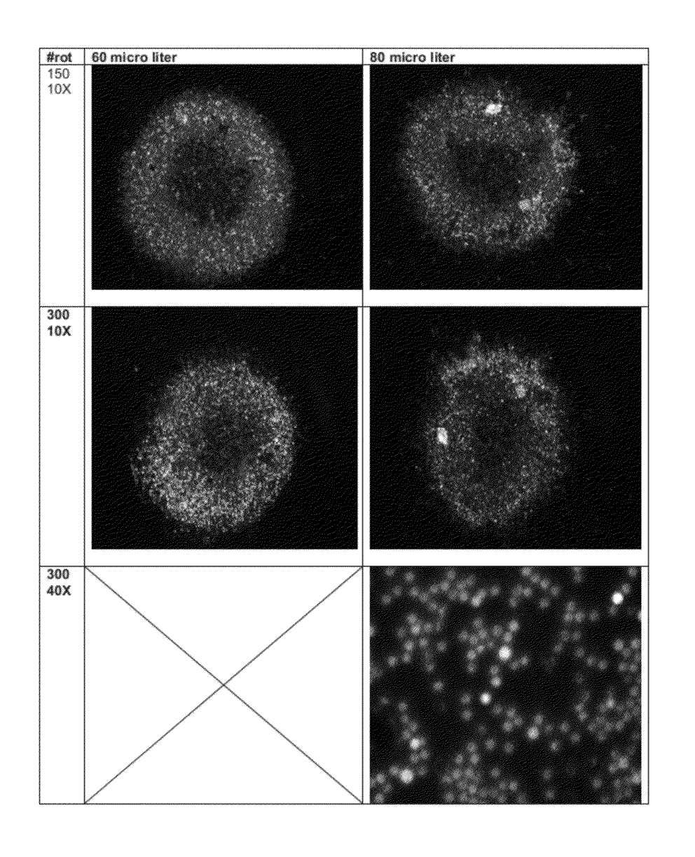

Images are acquired with a 5X and 40X objectives. As shown in FIGS. 11, 5x and 40x objectives were used to image 20, 40, 60 and 80 microliters of EpCam. The missing images shown in FIG. 8 were lost during saving.

While certain of the preferred embodiments of the present invention have been described and specifically exemplified above, it is not intended that the invention be limited to such embodiments. Various modifications may be made thereto without departing from the spirit of the present invention, the full scope of the improvements are delineated in the following claims.

What is claimed is:

1. A method for separating unbound immunomagnetic particles from target bound immunomagnetic particles in a biological specimen, comprising:
a. obtaining said biological specimen from a subject, wherein said specimen contains a mixture of unbound immunomagnetic particles and immunomagnetic particles bound to a target population;
c. adding a small permanent magnet directly to said specimen wherein the collection surface on said magnet is separated from said target population by a filter with a porosity size between said unbound immunomagnetic particles and said target population; and
d. separating said target population from said unbound immunomagnetic particles wherein said target population is collected on the surface of said filter and said unbound ferrofluid is collected on the collection surface of said magnet.

2. The target population of claim 1 wherein the target population are cells.

3. The target population of claim 2 wherein said target population is CD4 expressing cells.

4. The small permanent magnet of claim 1 wherein said magnet is neodymium.

5. The small permanent magnet of claim 1 wherein said magnet is a disc having a diameter of about 1.6 mm and a height of 0.8 mm.

6. The small permanent magnet of claim 1 coated with PDMS silicone.

7. The filter of claim 1 wherein said filter is a pillar structure.

8. A device for separating unbound immunomagnetic particles from target bound immunomagnetic particles in a biological specimen, comprising:
a. a filter with a porosity size between said unbound immunomagnetic particles and said target population;
b. a magnet with a collection surface; and
c. a spacer means to separate said filter from said collection surface wherein said spacer provides a volume to allow unbound immunomagnetic particles to traverse the filter and collect on said collection surface.

9. The filter of claim 8 wherein said filter is a pillar structure.
